(19) United States
(12) Patent Application Publication
(10) Pub. No.: US 2008/0316048 A1
(43) Pub. Date: Dec. 25, 2008

(54) SYSTEM AND METHOD FOR MONITORING A WELL

(75) Inventor: Raed H. Abdallah, Houston, TX (US)

Correspondence Address: G. Michael Roebuck, PC, FROST BANK BUILDING, 6750 WEST LOOP SOUTH, SUITE 920, BELLAIRE, TX, 77401, US

(73) Assignee: vMonitor, Inc., Houston, TX (US)

(21) Appl. No.: 12/055,995

(22) Filed: Mar. 26, 2008

Related U.S. Application Data
(63) Continuation-in-part of application No. 11/931,842, filed on Oct. 31, 2007.
(60) Provisional application No. 60/920,434, filed on Mar. 28, 2007.

(51) Int. Cl. G01V 3/00

(52) U.S. Cl. 340/854.6

(57) ABSTRACT

A well site data communication system is disclosed, the system including a receiver coupled to a first communication terminal that receives information using a first communication protocol; a transmitter coupled to the first communication terminal that sends information from the first communication terminal to a second communication terminal located at a well site using a second communication protocol; and a processor coupled to the first communication terminal configured as a protocol translator to change the received information from the first communication protocol to the second communication protocol. A method for well site communication is also disclosed. A data structure used by the system and method is also disclosed.

### RELATED APPLICATIONS

This application claims the benefit under 35 USC 120 and is a continuation-in-part of co-pending U.S. Application No. 60/920,434 filed Mar. 28, 2007 and U.S. application Ser. No. 11/931,842 file Oct. 31, 2007, the full disclosures of with are hereby incorporated by reference herein in entirety their.

### BACKGROUND

1. Technical Field

The present disclosure relates generally to well site management and, more particularly, to apparatuses, methods and products relating to well site monitoring.

2. Background Information

The exploitation of hydrocarbon reserves includes several phases including production and processing at a well site. Well site activities include monitoring of several parameters of the well site to ensure safety at the site and surrounding areas and to ensure the produced hydrocarbon products, either at the raw product stage or during or after well site processing, have a desired quality.

Information obtained by well site monitoring is used by well site personnel and by off-site personnel and customers for various purposes, including control of the well site and recording various production and well site parameters.

### SUMMARY

The following presents a general summary of several aspects of the disclosure and is not an extensive overview of the disclosure. It is not intended to identify key or critical elements of the disclosure or to delineate the scope of the claims. The following summary merely presents some concepts of the disclosure in a general form as a prelude to the more detailed description that follows.

An illustrative embodiment describes a well site data communication system including a receiver coupled to a first communication terminal that receives information using a first communication protocol; a transmitter coupled to the first communication terminal that sends information from the first communication terminal to a second communication terminal located at a well site using a second communication protocol; and a processor coupled to the first communication terminal configured as a protocol translator to change the received information from the first communication protocol to the second communication protocol.

In another particular illustrative embodiment a method for well site data communication including receiving data at a receiver coupled to a first communication terminal using a first communication protocol; translating the received data from the first communication protocol to a second communication protocol; and sending data from a transmitter coupled to the first communication terminal to a second communication terminal located at a well site using the second communication protocol.

A method is disclosed for transmitting data in a wireless oil field environment, the method comprising, sensing a signal change rate for an input signal from an oil field apparatus; selecting a real time transmission mode when the signal change rate is less than a predetermined value; selecting a buffered data transmission mode when the signal change rate is greater than or equal to the predetermined value; and transmitting the data in the selected transmission mode from a wireless oil field environment. A system is disclosed for performing the method.

### BRIEF DESCRIPTION OF THE DRAWINGS

For detailed understanding of the present disclosure, references should be made to the following detailed description of the several embodiments, taken in conjunction with the accompanying drawings, in which like elements have been given like numerals and wherein:

FIG. 1 illustrates a non-limiting example of a well site having a monitoring system according to the disclosure;

FIG. 2 schematically illustrates a non-limiting example of a monitoring network topology according to the disclosure;

FIG. 3 schematically illustrates a non-limiting example of a gateway device method according to the disclosure;

FIG. 4 is a depiction of a node addressing in a particular illustrative embodiment;

FIG. 5 schematically illustrates a non-limiting example of another gateway device method according to the disclosure;

FIG. 6 is a non-limiting example of a method according to the disclosure;

FIG. 7 is a non-limiting example of a data structure used for well-site monitoring; and

FIG. 8 is another non-limiting example of a data structure used for well-site monitoring.

FIG. 9 is a schematic depiction of an transmitter system provided in an illustrative embodiment;

FIG. 10 is a schematic depiction of an receiver system provided in an illustrative embodiment;

FIG. 11 is a schematic depiction of a replicated signal in another illustrative embodiment;

FIG. 12 is a schematic depiction of a data structure provided in another illustrative embodiment;

FIG. 13 is a schematic depiction of a data structure provided in another illustrative embodiment; and

FIG. 14 is a flow chart of functions performed in another illustrative embodiment; data

FIG. 15 is a depiction of data structure provided in a illustrative embodiment.

### DESCRIPTION OF ILLUSTRATIVE EMBODIMENTS

Portions of the present disclosure, detailed description and claims may be presented in terms of logic, software or software implemented aspects typically encoded on a variety of computer readable media including, but not limited to, computer-readable media, machine-readable media, program storage media or computer program product. Such media may be handled, read, sensed and/or interpreted by a computer or information processing device. Those skilled in the art will appreciate that such media may take various forms such as cards, tapes, magnetic disks, and optical disks. Examples of magnetic disks include floppy disks and hard drives, and examples of optical disks include compact disk read only memory (“CD-ROM”) and digital versatile disc (“DVD”). It should be understood that the given implementations are illustrative only and do not limit the present disclosure.

Some portions of the present disclosure, detailed description and claims use the term information, data, message, and these terms may be used in the singular or plural form. The term information as used herein refers to any information relating to well site monitoring and may include any one or combination of data, signal, message, command, and response, any of which may be analog or digital and may be communicated by wireless or wired transmission.

In a particular illustrative embodiment a well site data communication system is disclosed. The system includes a receiver coupled to a first network node that receives information using a first communication protocol; a transmitter coupled to the first network that sends information from the first communication terminal to a second network node located in a network at a well site using a second communication protocol; and a processor coupled to the first communication terminal configured as a protocol translator to change the received information from the first communication protocol to the second serial communication protocol for communicating with a network node. In another particular illustrative embodiment the system further includes a mailbox flag indicating that a mailbox data is ready to be read by the first network node. In another particular illustrative embodiment the communication terminal includes an embedded radio controller that controls any one of a plurality of radio types used as the receiver and the transmitter.

In another particular illustrative embodiment the embedded radio controller includes firmware instructions in a computer readable medium. The instructions further include instructions to determine a radio type and instructions to translate a command to a protocol for the radio type. In another particular illustrative embodiment the first communication terminal includes a message storage that stores data prior to transmitting the information to the second network node. In another particular illustrative embodiment the system further includes a communication interface that communicates using an interface selected from the group consisting of a wired connection for transmitting the information, a communication interface that communicates using wireless short range unsolicited custom messaging protocol (UCMP), a communication interface that communicates using wireless long range UCMP and a communication interface that communicates using wireless long range Modbus.

In another particular illustrative embodiment the system further includes sensors in data communication with the first network node wherein the sensors are read and reported based on a command code received at the first communication terminal. In another particular illustrative embodiment the first network node is in a mode selected from the group consisting of sleep, partial power, full power and continuous. In another particular illustrative embodiment the first network node receives a command code to execute a command selected from the group consisting of change modes, read sensor, report, and reconfigure. In another particular illustrative embodiment the system further includes a plurality of nodes in a mesh network topology. In another particular illustrative embodiment each one of the plurality of nodes are in direct communication with a third party device and every other one of the plurality of nodes in the mesh network.

In a particular illustrative embodiment a method for well site data communication is disclosed. The method includes receiving data at a receiver coupled to a first network node using a first communication protocol; translating the received data from the first communication protocol to a second network node; and sending data from a transmitter coupled to the first network node to a second network node located at a well site using the second communication protocol. In another particular illustrative embodiment the method further includes reading a mailbox flag indicating that a mailbox data is ready to be read by the first network node. In another particular illustrative embodiment the communication terminal includes an embedded radio controller that controls any one of a plurality of radio types used as the receiver and the transmitter.

In another particular illustrative embodiment the embedded radio controller includes firmware instructions in a computer readable medium. The instructions further include instructions to determine a radio type and instructions to translate command data to a protocol for the radio type. In another particular illustrative embodiment the first network node includes a message storage that stores data prior to transmitting the information to the second network node. In another particular illustrative embodiment the method further includes communicating data over a communication interface that communicates using an interface selected from the group consisting of a wired connection for transmitting the information, a wireless short range UCMP, a wireless long range UCMP and a wireless long range Modbus.

In another particular illustrative embodiment the method further includes sensors in data communication with the first network node wherein the sensors are read and reported based on a command code received at the first network node. In another particular embodiment the first network node is in a mode selected from the group consisting of sleep, partial power, full power and continuous. In another particular illustrative embodiment the first network node receives a command code to execute a command selected from the group consisting of change modes, read sensor, report, and reconfigure. In another particular illustrative embodiment the method further includes a plurality of nodes in a mesh network topology, wherein each one of the plurality of nodes are in direct communication with a third party device and every other one of the plurality of nodes in the mesh network.

In a particular illustrative embodiment, one or more wireless transmitters are coupled or connected to an analog input or digital input device, such as an oil field apparatus such as a pressure sensor, communicating data to one or more wireless receivers connected to an analog output or digital output device. The wireless transmitter and receiver can be housed in a package suited or housing for industrial areas. The housing is a gas tight box in one embodiment. In another embodiment the wireless transmitter includes but is not limited to a main controller board, one more digital input input/output (IO) channels, one more analog input IO channels, a radio unit, and an antenna mounted to the housing and a power source (i.e. battery pack). The wireless receiver includes but is not limited to a main controller board including a processor and a computer readable medium containing data and a computer program, one more digital input IO channels, one more analog input IO channels, a radio unit, an antenna mounted on the housing and a power source (i.e., battery pack). In another embodiment a system is provided having at least one transmitter/receiver set, a number of transmitters communicating with a single receiver set, two or more sets of any combination of thereof.

A particular embodiment replaces cabling for applications that use a high data rate sampling (1 to 1000 MHz per second or more) using external or internal serial radio frequency (RF) radio or transmission control protocol (TCP) wireless Radio. In these high data rate applications substantially every change in value in the data input to the transmitter from the source (e.g., oil field apparatus) is detected, recorded and transmitted to the receiver where the change is output to a transmitter output channel. The output of the transmitter is received by a receiver system and output in a prescribed protocol or data type (digital or analog). Another particular embodiment detects and transmits substantially every change in value from the input source. A particular embodiment maintains the signal modulation width and preserves the signal detected at the input source and reproduces input signal at the output channel at the receiver system. There can be a delay in time between when the input source detects the signal change and when the receiver outputs the signal value.

A particular embodiment substantially optimizes data communication between the transmitter and receiver to reduce data traffic. In a particular embodiment, a wireless transmitter and sensor are provided that read analog and digital data. The data input to the transmitter is transmitted wirelessly to a wireless receiver. In a particular embodiment, a main controller, radio, one or more sensors (or one or more analog or digital input channels connected to external sensors), a radio, an antenna, a battery pack (optional can be powered by external source) and in a housing. A wireless receiver is provided that receives the input signal from one or more wireless transmitters. The wireless receiver provides a main controller, a radio, one more analog or digital output channels, a radio, an antenna, a battery pack (optional can be powered by external source) and a housing.

In another embodiment, the input signal is read from the wireless transmitter in different formats (i.e. 4-20 milliamps, 1-5 v, 0/1 digital input, etc). In another embodiment, as the wireless transmitter sends the data to the wireless receiver the transmitter designates the type of data transmitted (i.e. 4-20 milliamps, 1-5 v, 0/1 digital input, etc). In another embodiment, the wireless receiver is configured to output the signal in any format desired (i.e. 4-20 mA, 1-5 v, 0/1 digital input, etc). In another embodiment the main controller unit for the transmitter is configured for continuous reading (sampling up 1000 or more readings per second) of one or more input channels. In another embodiment, the main controller unit is configured to detect signal changes in any of the input channels and immediately transmit the new value to the wireless receiver. In another embodiment, the main controller unit is configured to read incoming data from one or more transmitters and immediately output the data to a designated output channel.

In another embodiment, a main controller unit is configured to transmit data at predefined period (normally 1 sec) to the wireless receiver. Every 1 second (or whatever the defined period is) any change in the input signal is detected and stored to preserve the signal duration and signal value and substantially all the changes in the input signal are stored in a transmission data buffer. At the end of the transmit period all the changes in the input signal along with the width of each change are transmitted to the wireless receiver. In another embodiment, the main controller unit is configured read to incoming buffered data in the transmission data buffer and sequentially output the signal from the incoming buffer data to the designated output channel for that transmitter to preserve and enable replication of the signal width and value.

In another embodiment, the transmitter reads incoming data fast enough to ensure that the radio incoming transmission data buffer does not over flow. One way to do this is to have a dedicated thread that simply reads data from the incoming serial buffer and moves the data to another data buffer so that other threads (i.e., the outputting signal thread) to read it and perform some action with it (i.e., output the data to the output channel). In another embodiment, there is more than one of wireless receiver, each of which receives data from one or more wireless transmitters. In another embodiment, to reduce wireless traffic and wireless data collisions, transmitter radios of different frequencies are provided or radios with the same frequency but with different communication channel settings are provided.

In another embodiment, a messaging protocol is provided and used between the transmitter systems and receiver systems to identify messages from the different transmitters/receivers, error detection/correction, identify message types, pair input/output channels, etc. The messaging protocol consists of a message header, message body and message footer. In another embodiment, there are two types of techniques or transmission mode used in signal replicating and transmission. The first transmission mode is the real time transmission mode that is utilized for low frequency signals or signal change rates (for example, a signal change rate less than 10 Hz per second) and other for high frequency signals or signal change rate (for example, a signal change rate greater than or equal to 10 Hz per second). The signal change rate at which different transmission modes are selected can be higher than 10 Hz, for example, instead of 10 Hz, another embodiment switches at 100 Hz and another embodiment switches transmission modes at 1000 Hz and yet another embodiment switches transmission modes at 1 Kilo Hz.

In low frequency applications the transmitter is substantially continuously scanning the input channels for changes in value. Whenever a change in the signal value is detected the changed value is immediately transmitted to the receiver. At the receiver the low frequency message reporting the changed value is immediately output to the output channel. In high frequency applications the transmitter continuously scans the input channels for change in value. However instead of immediately transmitting the value to the receiver system, the value is stored in a transmission data buffer. After a predefined X time (can range from 1 sec to x minutes) the transmitter will send all the detected signal changes in the data buffer to the receiver. To preserve data integrity and signal width the time length for each signal or changed a data value is transmitted as well.

At the receiver system, once the message is received the receiver starts outputting the values as they are stored in the transmitted data buffer. The receiver uses the time length associated for each value to determine how long to wait before outputting the next value in the data buffer. With this method every x time or period the transmitter sends all the data representing changes detected and the receiver uses a “play back” technique to out put these data representing changed values to reproduce the signals as detected at the transmitter. In another embodiment, to preserve data integrity for high frequency signal change rates a sampling duration, such as a 1 second sampling duration, is divided into internals. In another embodiment them number of internals is equal to the maximum number of scanning channels available on the transmitter. Thus if the maximum scan rate for channel is 500 samples per second then each sampling duration of 1 second is divided into 500 internals. Each second (or sampling duration) the transmitter transmits all changed data values and a bit stream indicating intervals in which a value change was detected. So if there was a change value during intervals 5, 50, 100, 200, 311 of the 500 intervals during the sampling duration, then a table of data is sent representing the N bits and the changed values. The receiver outputs the value received based on the bit marked interval. This way the input signal width is preserved in the output signal.

In another embodiment, the transmitter system automatically detects how fast the input value is changing and can auto switch between the instantaneous messaging (slow frequency) and buffered messaging (high frequency). In another embodiment, to cancel and reduce the noise impact the transmitter system provides a signal edge detection tolerance so it can detect and eliminate spurious, noisy, bogus or fake signals which can over flow the communication out put transmission channel if not detected. In another embodiment the size of a transmission buffer is monitored and a transmission mode selected based on avail able space in the transmission buffer.

In another embodiment, a method is disclosed for transmitting data in a wireless oil field environment, the method comprising sensing a signal change rate for an input signal from an oil field apparatus; selecting a real time transmission mode when the signal change rate is less than a predetermined value; selecting a buffered data transmission mode when the signal change rate is greater than or equal to the predetermined value; and transmitting the data in the selected transmission mode from a wireless oil field environment. In another embodiment of the method, the buffered data transmission mode further comprises sending once per period, a data buffer of N data values representing the input signal when a condition is met; and sending once per period a data buffer of changed data values and a set of N bits indicating which of the N data values correspond to the changed data values when the condition is not met. In another embodiment of the method the condition further comprises data transmission buffer available space exceeding data buffer size by a predetermined margin. The margin can be set to 50 percent or any value from 1-100 percent, so that the available space in the transmission buffer is 50 percent (or another set percentage) larger than the data buffer size. The margin is be dynamically adjusted based on the signal change rate.

In another embodiment of the method, the method further comprising dividing a sampling duration into N intervals, wherein each of the N data values corresponds to one of the N intervals. In another embodiment of the method the set of N bits, bits representing a changed data value are set to one and all other bits are set to zero. In another embodiment of the method, the number of intervals, N is increased as the signal change rate increases. In another embodiment of the method, the predetermined margin is proportional to N. In another embodiment of the method, the data buffer further comprises N start time values and N stop time values corresponding to the N data values. In another embodiment the method further comprises receiving the data in the selected transmission mode; and outputting the received data as output data, wherein the input data and the output data are signals selected from the group consisting of digital, village and current.

In another embodiment, a system is disclosed for transmitting data in a wireless oil field environment, the system comprising a processor in data communication with a computer readable medium; a computer program embedded in the computer readable medium, the computer program comprising instructions to sense a signal change rate for an input signal from an oil field apparatus, instructions to select a real time transmission mode when the signal change rate is less than a predetermined value and instructions to select a buffered data transmission mode when the signal change rate is greater than or equal to the predetermined value and instructions to transmit the data in the selected transmission mode from a wireless oil field environment. In another embodiment of the system, In another embodiment of the system, the buffered data transmission mode further comprises instructions to send once per period, a data buffer of N data values representing the input signal when a condition is met and sending once per period a data buffer of changed data values and a set of N bits indicating which of the N data values correspond to the changed data values when the condition is not met.

In another embodiment of the system, the condition further comprises data transmission buffer available space exceeding data buffer size by a predetermined margin. In another embodiment of the system, the computer program further comprises instructions to divide a sampling duration into N intervals, wherein each of the N data values corresponds to one of the N intervals. In another embodiment of the system, the set of N bits, bits representing a changed data value are set to one and all other bits are set to zero. In another embodiment of the system, the number of intervals, N is increased as the signal change rate increases. In another embodiment of the system, the predetermined margin is proportional to N. In another embodiment of the system, the data buffer further comprises N start time values and N stop time values corresponding to the N data values. In another embodiment of the system, the computer program further comprises instructions to receive the data in the selected transmission mode; outputting the received data as output data, wherein the input data and the output data are signals selected from the group consisting of digital, voltage and current.

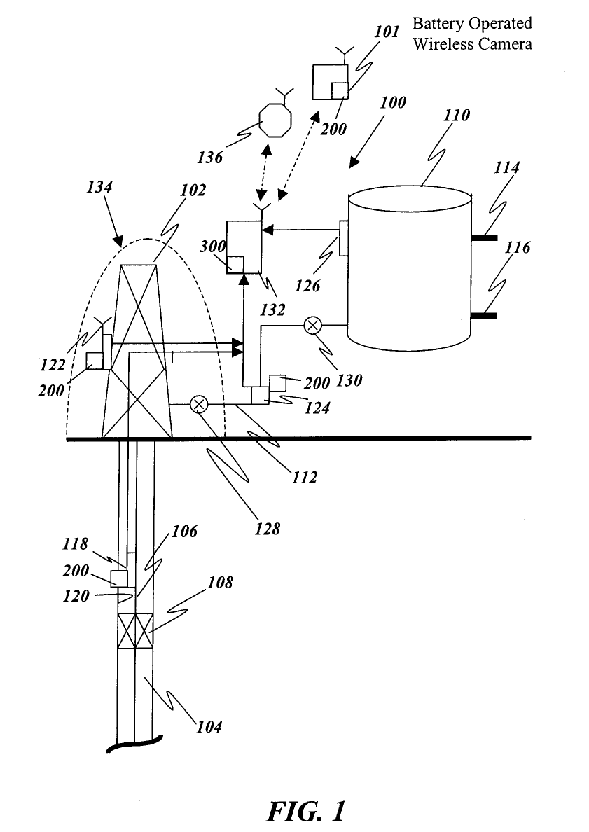

Turning now to FIG. 1, FIG. 1 is an elevation view of a well site 100 to illustrate a non-limiting example of a system according to the disclosure. The site 100 as shown includes a conventional well head 102 positioned at a producing well 104. The well 104 has disposed therein a production tube 106, which has been shut in by a barrier 108. The barrier 108 serves to isolate a lower portion of the well from an upper portion. In one example, the barrier 108 may be conventional packers.

The production tube 106 leads from within the well 104 to the well head 102 where the production tube connects to a product pipe 112. The product pipe 112, as shown, may lead to one or more tanks 110. The product pipe may include several valves 128, 130 for controlling fluid flow through the product pipe 112. The tank 110 may be used to temporarily store produced products. The product tank 110 may include one or several output pipes as illustrated in FIG. 1 by an upper output pipe 114 and a lower output pipe 116. The upper output pipe 114 may be used for example to recover light oils and gas from the tank 110, and the lower output pipe 116 may be used to recover heavier oils from the tank 110. Where the well site is a gas producing site, the tank 110 may be preceded by not-shown processing and pressurizing structures and devices. The tank 110, in the case of gas wells, may be a pressure vessel.

Continuing with FIG. 1, monitoring devices 118, 122, 124 and 126 are strategically located at several locations of the well site 100 to monitor any number of parameters relating to the produced products and/or well site tools. A transmission system 200 is included at each monitoring device. The monitoring devices can include a battery operated camera 101 for transmitting wireless video data to a receiving system. The camera stays in sleep mode unless motion is detected in associated motion detection. Upon detecting motion the camera wakes up, filing a predetermined video data segment duration and transmits the video data to a receiving system before going back to sleep. The monitoring devices may be in communication with a receiving system 300 at a local node gateway device 132 operating as a node controller. In several exemplary embodiments, the local node device includes output control interfaces coupled to well site tools such as the valves 128, 138 for controlling at least some operations at the well site. In a particular illustrative embodiment each monitoring device can be enclosed in a gas tight housing to prevent risk of an explosion due to electronic energy or spark igniting explosive gases near a monitored well. Each monitoring device can include one or more of a processor, computer readable media such as computer memory, database storage and a radio transceiver enclosed in the gas tight housing.

Portions of the well site as indicated by dashed line 134 may be designated as a hazardous or explosive zone due to, among other possible reasons, potentially hazardous or explosive gases or other products being produced at a particular well site 100. In some cases, the node controller 132 may be located outside of the predetermined hazardous or explosive zone. The gas tight housing reduces risk of explosions in the explosive zone.

Any number of useful monitoring devices may be employed at the well site 100 and at any number of locations. Non-limiting examples of monitoring devices and locations include one or more sensors 118 disposed within the borehole of the well 104 for monitoring down hole parameters of the well site. These down hole sensors may be permanently or temporarily disposed within the well 104. The down hole sensors 118 may be coupled to the outside of the production tube 106, to the inner flow channel of the production tube 106, inside a wall of the production tube 106, to or within a casing 120 or any combination of these or other possible down hole locations.

In other non-limiting examples, any combination of surface sensors may be used to monitor surface parameters of the well site 100. Surface sensors may include, for example, a sensor 122 for monitoring parameters at the well head 102, a sensor 124 for monitoring parameters in and/or along the surface production pipe 112, and a sensor 126 for monitoring parameters associated with the storage tank 110. Each of the sensors 122, 124 and 126 may be a single sensor or multiple sensors. Non-limiting examples of sensors include absolute and differential pressure sensors, temperature sensors, flow sensors, multi-phase sensors, optical sensors, nuclear sensors, gas detectors, motion sensors, imaging sensors such as video and/or still cameras or any combination of these and other sensors useful for monitoring well site operations. Any or all of these sensors may be analog or digital sensors. In the case of analog sensors, analog to digital converters may be employed at the well site or at the sensor location to aide in the transmission and processing of information obtained by the sensors. In several non-limiting examples, the local node controller 132 may be placed in long-range wireless communication with a gateway device 136 for relaying information and messages to/from remote users or system devices such as a Supervisory Control and Data Acquisition (SCADA) system. In some cases it is desirable to communicate between a node monitoring device and the gateway 136. Therefore, the scope of the present disclosure includes communicating information to and from a monitoring device, which may be a sensor 122 or sensor cluster having a data communication with a communication device 132. In an illustrative embodiment the communication device 132 is a gateway, however, the communication device may also be any device capable of receiving and temporarily storing configuration message data in a mailbox for reading by another device or retransmission to another device.

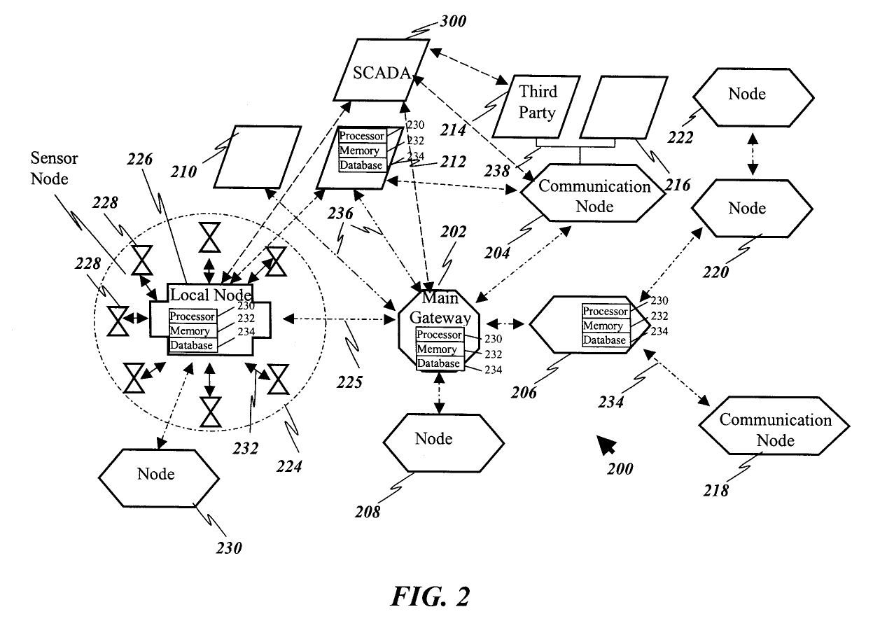

FIG. 2 schematically illustrates a non-limiting example of a well site monitoring network 200. In one non-limiting example, the network 200 may be employed for monitoring and remote control of several aspects of a well site such as well site 100 described above and shown in FIG. 1. The monitoring network 200 may be configured in any number of useful network topologies. For example without limiting the scope of the disclosure, the network 200 may be configured as a mesh network, a tree network, a linear network, or a star network. In one particular embodiment, the network 200 is configured using a mesh topology. Any topology suitable for digital and/or radio frequency communication may be used.

Continuing with the exemplary illustration of FIG. 2, the monitoring network may include a number of nodes. The central communication device gateway 202 in any of several configurations may be in communication with communication nodes 204, 206, 208. The central gateway 202 may also be in communication with third-party devices 210, 212. In the mesh topology every communication node 204, 206 and 208 as well as central gateway 202 in network 200 are individually addressable and can be in direct communication with each other and a third party communication device, such as a SCADA system through a serial mesh network. Thus, in the mesh topology, a third party device, such as a SCADA system can establish two-way communication with every node, including every remote node and every gateway node in the network. Each node 234 gateway in the network includes processor 230, memory 232, and database 234.

Nodes may operate as relay nodes to relay messages and data to other nodes or each node may receive data directly dependent on its node state. A sleeping node may be awakened to receive data and relay it or a node in partial mode may receive data to relay the received to another node. For example, communication node 204 is shown in communication with third party devices 214, 216, while another communication node 206 may operate as a relay between the central communication device, which may be a gateway 202 and another node 218. A relay node 206 may also be in communication with a second relay node 220 for communicating with additional nodes 222.

Continuing with FIG. 2, the central gateway 202 is in communication with a sensor node 224. The sensor node 224 may include a single sensor, or as shown, several sensors 228 configured as a sensor cluster with each sensor 228 in communication with a local node 226. The sensors 228 may be wireless sensors or connected to the node 226 using electrical cables, or the sensors 228 may be in communication with the local node 226 using any combination of wired and wireless communication devices. In the particular non-limiting example shown, the sensors are wireless sensors communicating with the local node 226 using a short range bi-directional communication interface 232. One illustrative embodiment of a wireless short range bi-directional communication interface 232 uses UCMP to communicate and relay messages among the network nodes. The sensor cluster 224 may be in communication with a node 230 in lieu of, or as shown, in addition to the main gateway 202.

The sensors 228 may be any number of sensor types for monitoring one or more parameters of a well site. In one example, the sensors 228 are wireless sensors. Non-limiting examples of sensors include absolute and differential pressure sensors, temperature sensors, flow sensors, multi-phase sensors, optical sensors, nuclear sensors, gas detectors, motion sensors, imaging sensors such as video and/or still cameras or any combination of these and other sensors useful for monitoring well site operations. Any or all of these sensors may be analog or digital sensors. In the case of analog sensors, analog to digital converters may be employed at the well site or at the sensor location to aide in the transmission and processing of information obtained by the sensors.

Communication among the nodes forming the network 200 and between the nodes and third party devices and users may be accomplished in any number of ways according to the present disclosure. In several non-limiting examples, communication may be wired or wireless. In some cases that communication may be either short range or long range and a particular node or several nodes may be provided with a combination of transceivers to allow for more than one type of communication with/from the node. Examples of wireless communication according to the disclosure include, but are not necessarily limited to, short-range wireless UCMP, long range wireless UCMP short-range Modbus and long-range wireless Modbus.

Modbus is a serial communications protocol published by Modicon in 1979 for use with its programmable logic controllers (PLCs). Modbus has become a de facto standard communications protocol in industry, and is now a commonly available means of connecting industrial electronic devices.

Two variants of Modbus exist, with different representations of numerical data and slightly different protocol details. Modbus RTU is a compact, binary representation of the data. Modbus ASCII is human readable, and more verbose. Both of these variants use serial communication. The RTU format follows the commands/data with a cyclic redundancy check checksum, while the ASCII format uses a longitudinal redundancy check checksum. Nodes configured for the RTU variant may not communicate with nodes set for ASCII, and the reverse. Modbus/TCP is very similar to Modbus RTU, but transmits the protocol packets within TCP/IP data packets.

In one example, a remote node such as the sensor cluster 224 may include a wireless short range bi-directional communication interface 232 using UCMP to communicate and relay messages between the wireless sensors 228 and the local node 226. In the example shown, the local node 226 includes a long-range UCMP interface for communicating with an external node 230. The main gateway 202 is shown in this example to have a long-range Modbus interface 236 for communicating with external users and devices 210, 212. The main gateway may also include long-range UCMP interfaces 224 for communicating with network nodes 204, 206, 208 and 224. The long range UCMP interfaces can transmit and receive from 1-20 miles or farther and may be used for communication among the network nodes, node 206 to node 220 for example as well as others. Although not shown, it should be understood that any interface shown here may be reconfigured as one of the other interfaces of the disclosure or their equivalents. A communication node 238 or local node 226 may be reconfigured as a central communication device so that a third party device may communicate directly with the local node 226 or communication node 238.

In an illustrative embodiment UCMP is provided to establish communication between gateway and a group of transmitter nodes in a serial wireless mesh network using UCMP as an extension of the serial Modbus RTU protocol. Thus existing serial wireless Modbus RTU communications are extended and used in an implementation of a serial wireless mesh network. This serial wireless mesh network enables communication with a network or serial RTU device through a single serial communication interface, which is a serial Modbus gateway in a particular illustrative embodiment. The UCMP protocol is provided to enable gateways and nodes in an illustrative embodiment to extend the serial Modbus RTU protocol to form a serial mesh network for low power radios that are intrinsically safe in an explosive environment (<1.5 mwatts). In another particular embodiment higher power radio >50-100 mwatts are enclosed in a gas tight box when used in an explosive environment.

In a particular illustrative embodiment the first information in each Modbus RTU message is the address of the receiver. This parameter contains one byte of information. In Modbus/ASCII it is coded with two hexadecimal characters, in Modbus/RTU one byte is used. Valid node addresses are in the range 0.247. The values 1.247 are assigned to individual Modbus devices (nodes) and 0 is used as a broadcast address. Messages sent to the broadcast address will be accepted by all slaves (nodes). A slave always responds to a Modbus message. When responding it uses the same address as the master in the request. In this way the master can see that the device is actually responding to the request. Within a Modbus device, the holding registers, inputs and outputs are assigned a number between 1 and 10000.

In an illustrative embodiment, each node or gateway has a child and/or a parent in the serial mesh network. Each node or gateway in the serial mesh network dynamically discovers or identifies its children and parents by “discovering” all other nodes or other gateways with which the node or gateway is connected in the serial mesh network. When a new node is added to the network the new node is discovered by other nodes to which it is connected. The new node has a quasi-unique hardware address assigned by a manufacturer or assigned dynamically by the gateway binary process. Duplicate “quasi-unique” manufacturer assigned addresses can be differentiated by combination with a node address in the UCMP protocol. The new node is assigned a network node address in the serial mesh network (1-x). The protocol, network address and hardware identifier (ID) for the newly discovered/added node are stored in a data structure identifying all nodes and their relationship to all other nodes in the serial mesh network. In another illustrative embodiment, the network is a parallel rather than a serial network communication network. The data structure may be distributed across memory in different gateways and nodes. Each node or gateway builds in a routing table identifying each of its children and parents with which the node or gateway is in serial or parallel communication. In a particular illustrative embodiment, when a serial Modbus message (e.g., a Modbus RTU protocol message) is received at a particular recipient node or gateway, the receiver address is checked by the recipient node or gateway. If the receiver address in the received Modbus RTU differs from the address of the recipient node or gateway the received message is not immediately ignored in UCMP. A further step is performed to see if a child of the recipient node has an address corresponding to the receiver address. The recipient node or gateway checks to see if the receiver address corresponds to one of its children which appear in the routing table stored at the gateway or node. If the receiver address corresponds to a child of the recipient node or gateway, the recipient node or gateway forwards the received Modbus message to a child in a serial communication path with the node identified by the receiver address. Thus, in an illustrative embodiment, a serial Modbus RTU protocol is extended to form a serial mesh network using UCMP.

In an illustrative embodiment the UCMP protocol frame is divided into 3 parts: Message Header, Message Body and 16 bit CRC. In one particular illustrative embodiment, the message header size is 13 bytes. Actual message header length will be defined by 13^{th} byte of message header. 1^{st} 13 bytes are interpreted as follows in table 1.

TABLE 1

| Byte | Bits | Description |
|---|---|---|
| 3 | | Network subnet mask ID. Up 255 different Mesh can be |
| | | defined (default is 0). |
| 4 | | Original Message sender node ID within Mesh Network. |
| 5 | | Relay Node Sender ID within the Mesh Network. |
| 6 | | Relay Node destination node ID within Mesh Network. |
| 7 | | Final Network Node ID destination. |
| 8 | 1-5 | Hardware Node Type of the Message Original sender. |
| | 6 | Acknowledge is required for this message |
| | | 0 - No Acknowledgement required (default). |
| | | 1 - Acknowledgement required |
| | 7-8 | Message priority |
| | | 00 - Normal, |
| | | 01 - Low, |
| | | 10 - High. |
| 9 | 1-7 | UCMP Type - Up to 128 messages can be defined. |
| | 8 | Final destination network node type. |
| | | 0 - Gateway Node (default), |
| | | 1 - Transmitter Node. |
| 10-11 | | Message Length - Total no of data bytes + 2 bytes of CRC. |
| | | It means remaining bytes with in message frame. |
| | | 10 - MSB |
| | | 11 - LSB |
| | | Combining 10 & 11 bytes will make unsigned integer. |
| 12 | | Message ID. This will be unique for each message sent by |
| | | sender node. Sender ID and Message ID will make message |
| | | unique in Mesh Network. Message ID will range from 1 to |
| | | 255. When it reaches 255, it will restart from 1. |
| 13 | | Message Header Length |

Bytes 3-7 as shown in Table 1, are referred to herein as Modbus registers. In another particular illustrative embodiment of the UCMP message, the Subnet Mask ID (Byte 3) is set to the Subnet Mask ID set for the node. A single node can support more than one Subnet Mask and in that case a separate message would be sent for every Subnet Mask ID. For instance, if a node is setup to support 2 Subnet Masks then there will be 2 messages sent out for each supported ID. The two messages are identical with only byte 3 of the header being different. The default Subnet Mask ID is 0.

A value of 255 in Byte 6 or Byte 7 indicates a Global Message destination Identifier. Original Message Node ID (byte 4) value is set by the original node sender should not change when messages are relayed en-route to the final destination. Relay Sender Node ID (byte 5) value should always be set to the value of the Node ID sending the message. This value is updated whenever the Node ID relaying the message relays a message. Relay Destination Node ID (byte 6) is the value of the next relay node ID. For a given network node, only one Relay Node is set for the Gateway Destination. The sender Node will update this value when sending its message unless it is a Global Message Destination (a value of 255). Final Destination Node ID (byte 7) is set by the original Node Sender ID and will not change value en-route to reach the final node destination.

For any network node the following is defined in the MODBUS registers (bytes 4, 5, 6 and 7 of the UCMP protocol): The Final Destination Gateway Node ID (Up to 3 Gateways destination can be defined). For each defined Final Destination Gateway ID one and only one To-Relay Node ID is defined. Note that if there is no To-Relay Node then the Gateway ID is set. Up to 246 From-Relay Node ID's can be set for a given Node ID. For instance, for a given Mesh Network where there are no To-Relay Nodes (all nodes talk directly to the Gateway) the Gateway will have all nodes listed in the From-Relay registers.

Bits 1-5 in byte 8 represent the hardware type of the Message Original Node. A total of 32 hardware types can be defined. Bit 8 of byte 9 of the message header should be set to 0 if the final destination is a Gateway (messages originating from Transmitter nodes). A value of 1 is used to represent messages being sent from the gateway to its network transmitter nodes.

To broadcast a global message from the Gateway the message has the following values for bytes 4 to 7: Byte 4: Gateway ID; Byte 5: Gateway ID; Byte 6: 255 and Byte 7: 255. To send a message from the Gateway to a specific node the following values for bytes 4 to 7: Byte 4: Gateway ID; Byte 5: Gateway ID; Byte 6: 255; and Byte 7: Node ID Destination.

In another particular illustrative embodiment, the UCMP protocol provides and follows the following UCMP Network Message Routing Rules.

### Rule 1

### Different Message Subnet Mask ID

### Rule Condition

Message Subnet Mask ID is different from the Node Subnet Mask ID.

### Rule Action

All nodes with different Subnet ID ignore the message (neither relayed nor consumed).

### Rule 2

### Relay Message with Gateway Destination

### Rule Condition

Gateway destination value (Bit 8 of Byte 9) is set to 0.
Relay Destination (Byte 6) equals to the Node ID
Relay Destination (Byte 6) NOT equal to the Final Destination (Byte 7)

### Rule Action

Node that meets the rule condition should:

Replace the Relay Sender value (byte 5) with the Node ID

Replace the Relay Destination value (byte 6) with the Node “To Gateway Relay” Node (stored in Modbus register) for the Gateway destination in Byte 7.

Resend the Message with the updated header routing information.

All other nodes ignore this message.

### Rule 3

### Final Gateway Destination

### Rule Condition

Gateway destination value (Bit 8 of Byte 9) is set to 0.
Relay Destination (Byte 6) equals to the Node ID
Relay Destination (Byte 6) equal to the Final Destination (Byte 7)

### Rule Action

Node that meets the above condition should:

Consume the Message and perform proper action based on the message type.

All other nodes should ignore this message.

### Rule 4

### Relay Message from Gateway to Specific Node ID

### Rule Condition

Gateway destination value (Bit 8 of Byte 9) is set to 1.
Relay Destination (Byte 6) equals to the Global Message ID (255).
From Relay Node ID (Byte 5) is equal to the Node “To Gateway Relay” Node ID.
The Node has network children for the gateway sending the message.
Node destination is not equal to the Node ID.

### Rule Action

Node that meets the rule condition should:
Replace the Relay Sender value (byte 5) with the Node ID.
Resend the Message with the updated header routing information.
All other nodes should ignore this message.

### Rule 5

### Final Transmitter Node Destination

### Rule Condition

Gateway destination value (Bit 8 of Byte 9) is set to 1
Final Destination (Byte 7) equals to the Node ID.
Relay Destination (Byte 6) is equal to the Global Message ID (255).
From Relay Node ID (Byte 5) equals to the Node “To Gateway Relay” Node.

### Rule Action

Node that meets the above condition should:

Consume the Message and perform proper action based on the message type

All other nodes should ignore this message.

### Rule 6

### Relay Global Message

### Rule Condition

Gateway destination value (Bit 8 of Byte 9) is set to 1
Relay Destination (Byte 6) is equal to the Global Message ID (255).
Final Destination (Byte 7) is equal to the Global Message ID (255).
From Relay Node ID (Byte 5) equals to the Node “To Gateway Relay” ID
Original ID (Byte 4) is equal to the Gateway Node Destination.
The Node has network children for the gateway sending the message.

### Rule Action

Node that meets the rule condition should:

Replace the Relay Sender value (byte 5) with the Node ID.

Resend the Message with the updated header routing information

All other nodes should ignore this message.

### Rule 7

### Global Message Final Destination

### Rule Condition

Gateway destination value (Bit 8 of Byte 9) is set to 1
Relay Destination (Byte 6) equals to the Global Message ID (255).
Final Destination (Byte 7) equals to the Global Message ID (255).
From Relay Node ID (Byte 5) is equal to the Node “To Gateway Relay” Node.
Original Node (Byte 4) equals to one of the Node Gateway Destinations.

### Rule Action

Node that meets the above condition should:

Consume the Message and perform proper action based on the message type

All other nodes should ignore this message.

Any nodes ignore any message it receives which does not meet any of the above 7 rules listed above. Also, all the Rules are mutually exclusive with the exception of Rule 6 and 7. A Global Message from the Gateway can trigger both rules for some network nodes. This means that the node will resend the message (with updated header routing information) and will consume the message as well.

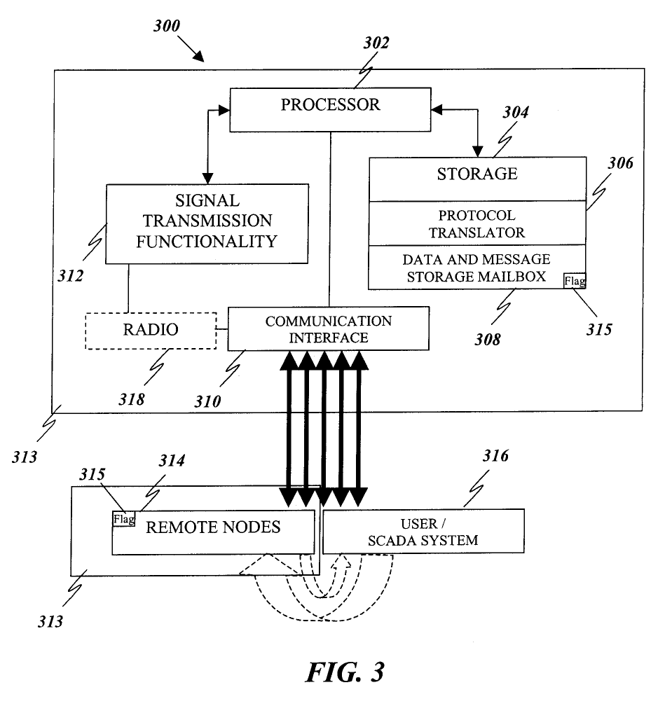

FIG. 3 is a non-limiting example of a node gateway 300. The gateway 300 communicates with other nodes and devices as described above and shown in FIG. 2 using one or more protocols. In a particular illustrative embodiment a Modbus RTU serial protocol is used. In other particular illustrative embodiment, other protocols may be used such as SNMP (Simple Network Management Protocol), Modbus Universal Plug and Play, or other selected protocols, which may include proprietary protocols.

In an illustrative embodiment, the central communicative device is a gateway 300 and includes a processor 302 and a computer readable storage medium 304. The gateway 300 may further include a protocol translator 306, data and message storage mailbox 308, communication interfaces 310 and imbedded signal transmission functionality or protocol 312. The signal transmission functionality circuit 312 may be coupled to the controller 302 and to the communication interface 310 via a radio transceiver 318. In one example, the imbedded signal transmission functionality or protocol 312 is firmware implemented to allow the use of any number of off-the-shelf radios 318 or other communication device such as a cell phone to act as a transceiver device. The signal transmission functionality may be implemented using a network packet routing protocol embedded in a firmware message. In this manner any commercially-available radio suitable for operation in a well monitoring environment may be used for simple over air data communication transfer to send and receive data or data packets. The data communication may be analog or digital radio frequency communication. Each node in the network, including but not limited to central gateway node 300 and remote node 314 can be enclosed in a gas tight housing to reduce risk of explosion due to radio frequency or electronic spark. Each of the nodes may be in a different mode including but not limited to sleep (only processor partially active), partial power (processor and either radio or sensors powered), full power (processor, radio and sensors powered temporarily) and continuous (processor, radio and sensors powered continuously). The message can be received and processed by a software agent such as an embedded radio controller running on a processor executive instructions from memory.

The network functionality firmware supports dynamic child nodes message routing and indexing and different network topologies, i.e., star, mesh, linear, tree, etc. with unlimited message hopping/routing capabilities. etc. In a particular illustrative embodiment, the network functionality firmware enables implementation of a serial mesh network using an extension of Modbus protocol, referred to herein as Unsolicited Modbus Custom Protocol (UCMP).

A firmware implemented data routing protocol is provided to implement network routing and command functionality. The data routing protocol may be less than 20 bytes. In one example the routing protocol may be about 13 bytes used to embed information for creating and managing a wireless network such as a wireless mesh network and for assigning message information. In one example, a wireless mesh network protocol may include a Network Subnet or Group ID, Relay Node ID's, a Final Destination ID, and an Original Node ID. Example message information assigned to the wireless mesh network protocol may be command code, priority, acknowledge (ACK), type, a sequence number, message length, and encryption type and key. The command code indicates action to be taken upon message receipt. A command code may indicate that a mail message is pending in the mailbox, configuration is required or a sensor read and report is requested or change mode requested (sleep mode to continuous mode).

In several illustrative embodiments, the gateway 300 operates using the processor 302 and instructions in the computer readable storage medium 304 for communication with remote nodes 314 and third party users and devices such as SCADA devices 316. In one non-limiting example, the node gateway 300 supports a local wireless network and a larger network such as the larger network 200 described above.

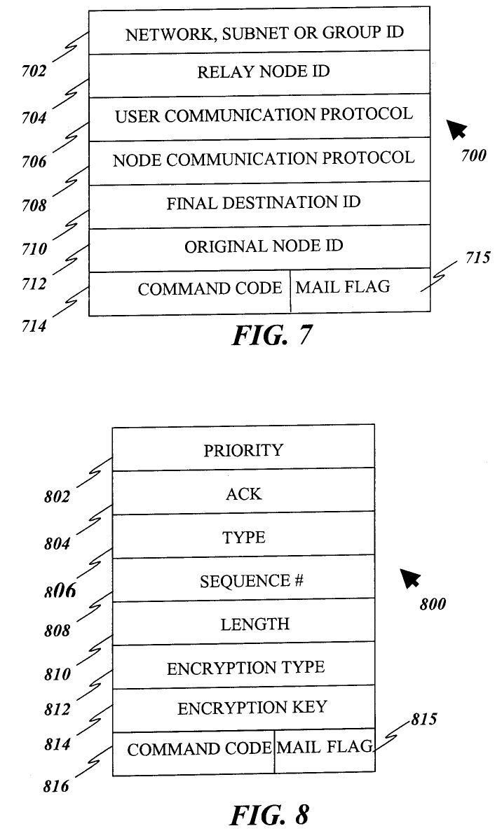

In one non-limiting example, access to a remote node from a third-party user or device 316 is accomplished via the gateway 300 in a manner transparent to the user or third party device such as a Supervisory Control and Data Acquisition (SCADA) system such that the user or SCADA system communicating with the gateway 300 operates as if communicating directly to the remote node as indicated by dashed block arrows in the figure. FIGS. 7 and 8 show illustrative data structures used for data communication and protocol translation in different particular illustrative embodiments.

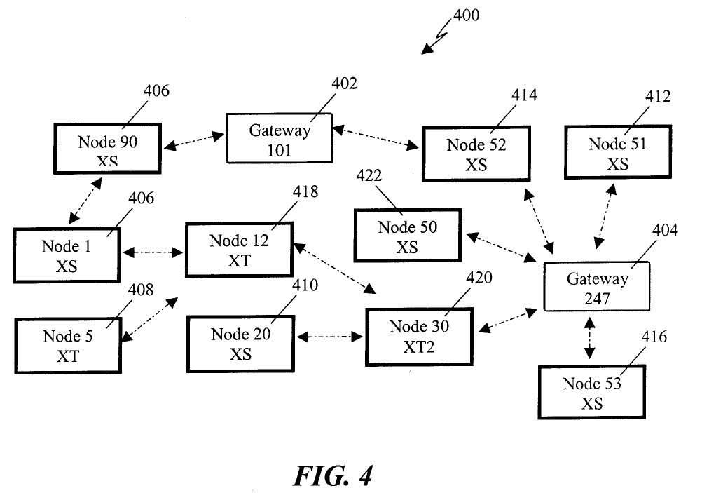

FIG. 7 is a non-limiting example of a data structure embedded in a computer readable medium used for well-site monitoring. The data structure 700 may be stored in a computer-readable medium such as the gateway storage 304, or in the case of a remote node, storage 404 as shown in FIG. 4 to be described later. In one example, the computer-readable medium 304, 404 has stored thereon a data structure 700 that includes a first field 702 containing data representing identification (ID) of a desired network, sub network or group. A network may for example be the network 200 described above, and a group may be a node group, say nodes 220, 222 in FIG. 2. A group may also be a sensor group such as sensor cluster 224 of FIG. 2. A second field 604 may contain data representing identification of a relay node, node 206 of FIG. 2 for example. A third field 706 may contain data representative of a user communication protocol, and a fourth field 708 may contain data representative of a node communication protocol. A fifth field 710 may contain data representing a final destination ID such as an address of a node or sensor to receive information from a user. A sixth field 712 may contain data representative of an original node ID such as an address of a sender node in the case of a relay or an address of the main or local gateway. A seventh field 714 may contain data indicative of a command code and mailbox flag 715 indicating routine or priority mail.

FIG. 8 is another non-limiting example of a data structure used for well-site monitoring to allow messaging among nodes and gateways forming a network such as the network 200 described above and shown in FIG. 2. In the example of FIG. 7, a data structure 800 may be stored on a computer-readable medium such as storage 304 of FIG. 3, or in the case of a remote node, storage 404 as shown in FIG. 4. In one example, the computer-readable medium 304, 404 has stored thereon a data structure 800 that includes a first field 802 containing data representing message priority. A second field 804 contains data representing acknowledgement of a received message, and a third field 806 contains data representing a message type. A fourth field 808 may contain data representing a message sequence number and a fifth field may contain data representing message length. Encryption, when used, may be accomplished by using data fields 812, 814 contain data representing encryption type and encryption key. A fifth field 816 may contain data indicative of a command code and mailbox flag 815 field containing data indicating routine and priority mail.

Continuing with the example of FIG. 3, a user or SCADA system in one example uses serial Modbus protocol to send commands to the gateway 300 or to any number of remote nodes via the gateway 300 using a single communication path. The Modbus command has a byte ID signifying the destination of the node that is to respond to this command. The Modbus protocol imbedded in the controller includes instructions to operate as a router. When the gateway 300 receives a command, the gateway will respond if a command ID matches the gateway 300 ID. Where the command ID does not match the gateway ID, then the gateway protocol will operate to poll connected nodes for a node ID matching the command ID. Matching a command ID to a remote node ID results in the gateway protocol using a routing header to send the command or message to the appropriate node.

In another particular illustrative embodiment, child nodes are dynamically discovered by a parent gateway or parent node with which the child nodes are in hierarchical wireless data communication as prescribed by the serial mesh network. This hierarchical arrangement of serial communication nodes in the serial mesh network is stored in data structure embedded in a computer readable medium. The data in the data structure indicates the hierarchical relationship between all nodes and gateways in the serial mesh network. The data structure data contains the hierarchical structure of the serial mesh network, indicating parent child relationship for all nodes and gateways in the serial mesh network. Thus, when a message is received by a recipient node or gateway, the recipient node or gateway can access the data structure to identify its children in the message network. If the received message is addressed to a child of the recipient node or gateway, the received message is passed on to the child node. If the received message is not addressed to the recipient node or gateway or to a child of the recipient node or gateway, the received message is ignored.

A node response message may be received back from the node at the gateway 300. The controller deconstructs any received node response message, e.g. translates the message and sends the response back to the user/SCADA system sending the original command. Thus the gateway routing and translation are transparent to the user/SCADA system, and it appears to the user that it is communicating directly with the node.

The messaging 308 may be implemented in any number of useful storing schemes. For example, messaging 308 may be implemented as a database accessible from a remote user, node or gateway. In another example, messaging may be implemented as an electronic bulletin board hosted at a gateway or memory hosted by the gateway or node. In another example, the messaging may be implemented as an electronic mailbox feature.

A network node according to the present disclosure may operate in a sleep mode. Data and message storage mailbox 308 may be used to store messages or commands coming to the central gateway 300 for processing at the central gateway level. A command may be received at the main gateway 300 for changing a node feature of a connected node. The central gateway 300 may be used to deposit the command as a message in a mailbox/message queue in data and message storage mailbox 308. The data and message storage mailbox 308 can be configured to send a data received signal to a remote node memory mailbox flag 315 when the message is received at the mailbox 308 without intervention of the central gateway 300. The data received signal can be registered in a mail flag storage register 315 at the remote node or gateway 320 without waking up the remote node for which the message is intended. The mail flag storage register 315 is cleared at the remote node by the remote node when the mail flag is sensed by a remote node prior to checking the gateway for mailbox messages. The mail storage flag can be set as “priority” code “01” for waking up the remote node immediately to respond to the priority flag and read the mailbox or “routine” code “07” so that the remote node will read the flag when it wakes up and responds to the routine flag when the node wakes up, rather than immediately. The mail storage flag 315 can be stored at the remote node memory and/or at the central gateway memory.

Each network node (central gateway and remote node) can have a unique data storage area to store a message queue or act as a mailbox. Initial configuring message data or mail for new nodes are used to assign ID, etc. is prepared and stored for future nodes added to the network. If an intended message or data recipient node is in sleep mode, the node can change from the sleep mode to wake mode for sampling well sensor data and when appropriate for transmitting a report containing data and information such as sensor readings and device state from time to time under predetermined conditions. In another particular embodiment, when the node wakes up to transmit the information to the gateway 300 to storage 304, a command can be sent by the node to the gateway 300 to storage 304 for checking if a mailbox flag is set indicating that there are commands in the message queue or data in the mailbox 308 to be downloaded to the node. The remote node or any network node may also directly access the mailbox without intervention by the gateway node 300. Where messages or data are in the node queue, the node may request the gateway to send the messages or data. The node may be configured to automatically revert to the sleep mode after receiving all the data/messages and sending all information.

In one example, the gateway processor 302 may be used to transmit a command to a node in sleep mode for waking up the node on demand and download queued messages and data instead of, or in addition to, waiting for the node to wake up at the next specified/scheduled interval. In one embodiment, messages may be prioritized such that the message may be one that requires waking the node or one that may remain in the queue until the node requests messaging. Nodes send reports to the central gateway or SCADA system based on time interval and exceptions. The reports include sensor measurement data and node statistics such as number of power on cycles and their duration encountered since the last report. A cumulative count of the power on cycles and duration can be used to estimate battery life at remote nodes.

Nodes may be requested to awaken and check sensor data to determine if an exception has occurred in the sensor data. Exceptions may be based on a percent change between a programmable set number of readings, a sensor threshold value, a digital or analog signal or a timed event. Exceptions and timed reports are reported to the SCADA via the mailbox, gateway or direct message to the SCADA.

Turning now to FIG. 4, an illustrative embodiment of message header routing is depicted. FIG. 4 depicts a mesh network is a 2 gateway destination with relay nodes 402 and 404. Nodes 1 406, 5 408, 20 410, 50 422, 51 412, 52 414 and 53 416 are terminating nodes with no children (not being used by other nodes to relay messages to the gateway). All nodes in FIG. 4 are shown having the same Subnet Mask ID. The following tables illustrate the Modbus register settings for bytes 3-7 in the UCMP protocol shown in table 1.

### Nodes MODBUS Registers Settings

### Node 1

TABLE 2

| Register | Value |
|---|---|
| 46001 | 247 |
| 46002 | 101 |
| 46006 | 12 |
| 46007 | 90 |

### Node 5

TABLE 3

| Register | Value |
|---|---|
| 46001 | 247 |
| 46006 | 12 |

### Node 90

TABLE 4

| Register | Value |
|---|---|
| 46001 | 101 |
| 46006 | 101 |
| 46101 | 1 |

### Node 12

TABLE 5

| Register | Value |
|---|---|
| 46001 | 247 |
| 46006 | 30 |
| 46101 | 1 |
| 46102 | 5 |

### Node 20

TABLE 6

| Register | Value |
|---|---|
| 46001 | 247 |
| 46006 | 30 |

### Node 30

TABLE 7

| Register | Value |
|---|---|
| 46001 | 247 |
| 46006 | 247 |
| 46101 | 12 |
| 46102 | 20 |

### Nodes 52

TABLE 8

| Register | Value |
|---|---|
| 46001 | 247 |
| 46002 | 101 |
| 46006 | 247 |
| 46007 | 101 |

### Nodes, 50, 51, 53

TABLE 9

| Register | Value |
|---|---|
| 46001 | 247 |
| 46006 | 247 |

### Gateway Node 247

TABLE 10

| Register | Value |
|---|---|
| 46101 | 30 |
| 46102 | 50 |
| 46103 | 51 |
| 46104 | 52 |
| 46105 | 53 |

### Gateway Node 101

TABLE 11

| Register | Value |
|---|---|
| 46101 | 90 |

The following illustrates a Message Routing Sequence for the nodes shown in FIG. 4. Note that if none of the 7 rules apply then the message is ignored by the receiving node.

### Node 1 Message Sequence

Since Node 1 has two Gateway Destinations it will send 2 instances each message. The first message is for destination 247 and the second message is for destination 101.

### Destination 247 Routing Sequence

Node 1 sends: 1, 1, 12, 247

Node 12 sends: 1, 12, 30, 247 (Rule 2)

Node 30 sends: 1, 30, 247, 247 (Rule 2)

Node 247 consumes the message (Rule 3)

### Destination 101 Routing Sequence

Node 1 sends: 1, 1, 90, 101

Node 90 sends: 1, 90, 101, 101 (Rule 2)

Node 101 consumes the message (Rule 3)

### Node 5 Message Sequence

Node 5 sends: 5, 5, 12, 247

Node 12 sends: 5, 12, 30, 247 (Rule 2)

Node 30 sends: 5, 30, 247, 247 (Rule 2)

Node 247 consumes the message (Rule 3)

### Node 90 Message Sequence

Node 90 sends: 90, 90, 101, 101

Node 101 consumes the message (Rule 3)

### Node 12 Message Sequence

Node 12 sends: 12, 12, 30, 247

Node 30 sends: 12, 30, 247, 247 (Rule 2)

Node 247 receives and consumes the message.

### Node 20 Message Sequence

Node 20 sends: 20, 20, 30, 247

Node 30 sends: 20, 30, 247, 247 (Rule 2)

Node 247 consumes the message (Rule 3)

### Node 30 Message Sequence

Node 30 sends: 30, 30, 247, 247

Node 247 consumes the message (Rule 3)

### Node 50 Message Sequence

Node 50 sends: 50, 50, 247, 247

Node 247 consumes the message (Rule 3)

### Node 51 Message Sequence

Node 51 sends: 51, 51, 247, 247

Node 247 consumes the message (Rule 3)

### Node 52 Message Sequence

Node 52 has two gateway destinations.

### Destination 247 Routing Sequence

Node 52 sends: 52, 52, 247, 247

Node 247 consumes the message (Rule 3)

### Destination 101 Routing Sequence

Node 1 sends: 52, 52, 101, 101

Node 101 consumes the message (Rule 3)

### Node 53 Message Sequence

Node 53 sends: 53, 53, 247, 247

Node 247 consumes the message (Rule 3)

### Gateway 247 Message Sequence to Target

There are two cases: For nodes that are child nodes of the gateway and nodes that are not. Using Node 1 and 5 as an example below are the routing sequence for each node.

### Node 1

Since Node 1 is not an immediate child node of the gateway (not in the Child Node registers 46101-46347) the following routing sequence takes place.

Node 247 sends: 247, 247, 256, 1

Node 50, 51, 52, and 53 do not relay since the have any child nodes (see MODBUS registers).

Node 30 sends: 247, 30, 256, 1 (Rule 4)

Node 20 does not respond since the have any child nodes (see MODBUS registers).

Node 12 sends: 247, 12, 256, 1 (Rule 4)

Node 1 consumes the message (Rule 5).

### Node 5

Since node 50 is an immediate child node to the gateway (register 46102) the following sequence takes places

Node 247 sends: 247, 247, 50, 50

Node 50 consumes the message (Rule 5).

### Gateway 247 Global Message Sequence

Node 247 sends: 247, 247, 256, 256

Node 30, 50, 51, 52, and 53 each consumes the message (Rule 7).

Node 50, 51, 52, and 53 do not relay the message since none of these nodes have any network children.

Node 30 sends: 247, 30, 256, 256 (Rule 6)

Node 12 and 20 consume the message relayed by node 30 (Rule 7).

Node 20 does not relay the message since it does not have any network children

Node 12 sends: 247, 12, 256, 256 (Rule 6)

Node 1 and 5 consume the message relayed by node 12 (Rule 7).

Node 1 and 5 do not relay the message since none of these nodes have any network children.

### Gateway 101 Message Sequence to Target

If Node 1 is the target node the following routing sequence takes place.

Node 101 sends: 101, 101, 256, 1

Node 52 does not relay the message since the have any child nodes (see MODBUS registers).

Node 90 sends: 101, 90, 256, 1 (Rule 4)

Node 1 consumes the message (Rule 5).

For Node 90 as the target node the following routing sequence takes place

Node 101 sends: 101, 101, 90, 90

Node 90 consumes the message.

For Node 50 as the target node the following routing sequence takes place

Node 101 sends: 101, 101, 50, 50

Node 50 consumes the message.

### Gateway 101 Global Message Sequence

Node 101 sends: 101, 101, 256, 256

Node 90 and 52 each consumes the message (Rule 7).

Node 52 does not relay the message since none of these nodes have any network children.

Node 90 sends: 101, 90, 256, 256 (Rule 6)

Node 1 consumes the message relayed by node 30 (Rule 7).

Node 1 does not relay the message since none of these nodes have any network children.

In a particular illustrative embodiment, the function codes shown in table 12 are provided.

TABLE 11

| Message | Description | Sender | Receiver |
|---|---|---|---|
| Startup | When transmitter is powered up, it will | Transmitter | Gateway |
| (Initialization) | send startup command to gateway. This | | |
| | way gateway will come to know that | | |
| | new transmitter is added in Mesh | | |
| | Network. | | |
| Shutdown | When transmitter is power down or | Transmitter | Gateway |
| | firmware application exit in normal | | |
| | condition, it will send shutdown | | |
| | command to gateway. This way gateway | | |
| | will come to know that particular | | |
| | transmitter is no longer exists in Mesh | | |
| | Network. | | |
| NewMessage | Transmitter sends this command to | Transmitter | Gateway |
| | gateway to check if any new message is | | |
| | available in its Inbox. In response to this | | |
| | command, gateway will send number of | | |
| | new messages available. | | |
| MessageAvailable | Gateway sends this message in response | Gateway | Transmitter |
| | to New Message command received | | |
| | from transmitter. | | |
| SendMessage | Transmitter sends this message to | Transmitter | Gateway |
| | retrieve message from its Inbox. | | |
| | Transmitter sends one command per | | |
| | message in Inbox. | | |
| NextNodeID | Transmitter sends this message to find | Transmitter | Gateway |
| | out next available node ID with in Mesh | | |
| | Network. | | |
| AvailableID | Gateway sends this message in response | Gateway | Transmitter |
| | to NextNodeID message received from | | |
| | transmitter. | | |
| DownloadFile | Gateway sends this message to | Gateway | Transmitter |
| | transmitter to start downloading | | |
| | configuration file available at gateway. | | |
| SendINIFile | Transmitter sends this message to | Transmitter | Gateway |
| | gateway to download particular INI | | |
| | configuration file. | | |
| UploadFile | Gateway sends this message to | Gateway | Transmitter |
| | transmitter in response to SendINIFile | | |
| | message. Same message is used to | | |
| | upload any file to Gateway from | | |
| | PDA/PC. | | |
| SetNodeID | Gateway sends this message to | Gateway | Transmitter |
| | transmitter to change it node ID. | | |

When a transmitter is powered up, it will send a startup command to a gateway. This way gateway will come to know that new transmitter is added in Mesh Network. When transmitter is powered down or firmware application exits in normal condition, it will send a shutdown command to gateway. This way gateway will come to know that particular transmitter no longer exists in mesh network. A transmitter node sends a new message command to gateway to check if any new message is available in its Inbox. In response to this command, gateway will send number of new messages available. A gateway sends a message available command in response to a new message command received when a message is available in the mail box or gateway memory. A transmitter sends a send message command to retrieve message from its Inbox. The transmitter sends one command per message in Inbox. The transmitter sends a next node ID message to find out next available node ID with in Mesh Network. A gateway sends available ID message in response to Next Node ID message received from transmitter. A gateway sends a down load message to transmitter to start downloading configuration file available at gateway. A transmitter sends a send INI message to gateway to download particular INI configuration file. The gateway sends an Upload message to transmitter in response to Send INI File message. The same message is used to upload any file to Gateway from PDA/PC. The gateway sends a set node ID message to transmitter to change it node ID.

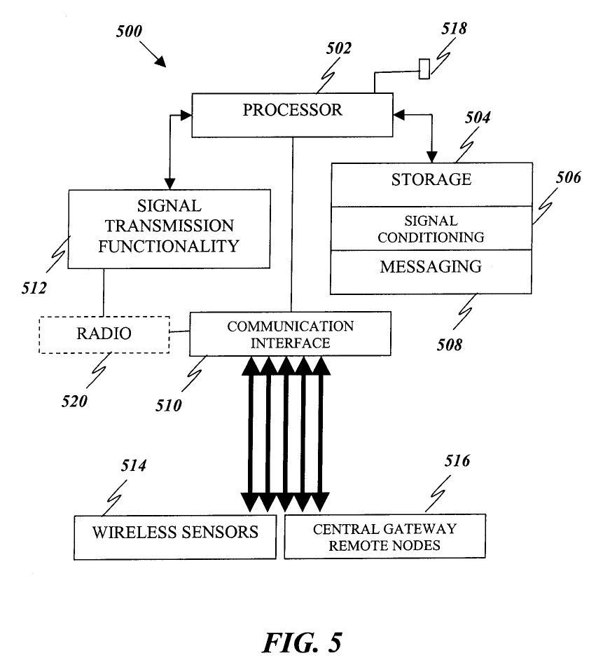

Turning now to FIG. 5, FIG. 5 is a non-limiting example of a local node or gateway 500. The local gateway 500 may be used for example to configure a wireless sensor cluster 514, which may be similar to the sensor cluster 224 described above and shown in FIG. 2. The local gateway 500 includes a controller 502 and a storage medium 504. The local gateway 500 may further include a signal conditioning circuit 306, message storage 308, and a signal transmission functionality circuit 512, which may be implemented in firmware. The signal transmission functionality circuit 512 is coupled to the controller 502 and to the communication interface 510 via a radio transceiver 520. In one example, the signal transmission functionality 512 is firmware implemented to allow the use of any number of off-the-shelf radios 520 as transceiver devices. The signal transmission functionality may be implemented using a network packet routing protocol embedded in a firmware message similar to that described above with respect to the example of FIG. 3. In this manner any commercially-available radio suitable for operation in a well monitoring environment may be used for simple over air data transfer to send and receive data packets.

The UCMP routing protocol may be less than 20 bytes. In one example the UCMP routing protocol may be about 13 bytes used to embed information for creating a wireless network such as a wireless mesh network and for assigning message information. In one example, a wireless mesh network protocol may include a Network Subnet or Group ID, Relay Node ID's, a Final Destination ID, and an Original Node ID. Example message information assigned may be priority, acknowledge (ACK), type, a sequence number, message length, encryption type/key and command code. A transmitter sends INI message to gateway to download particular INI configuration file.

In several embodiments, the gateway 500 operates using the processor 502 and instructions in the storage medium 504 for communication with sensor nodes 514, with the central gateway and with other remote nodes 516. In one non-limiting example, the node gateway 500 supports a local wireless network and a larger network such as the larger network 200 described above.

An input interface 510 may include either or both of an analog receiver and a digital receiver for receiving signals from sensors 514. Signals from the sensors 514 received at the interface 510 are conditioned locally such that sensor brand and/or type are transparent to a main gateway/SCADA interface 515, which may for example be interface 312 described above and shown in FIG. 3. In this manner, messages may be relayed to/from a main gateway/SCADA and the wireless sensors 514 without special configuration based on the type/brand of sensors used.

The messaging 508 may be implemented in any number of useful storing schemes. For example, messaging 508 may be implemented as a database accessible from a remote user, node or gateway. In another example, messaging may be implemented as an electronic bulletin board. In another example, the messaging may be implemented as an electronic mailbox feature. A mailbox flag is set when mail arrives into a mailbox for a recipient.

A network node according to the present disclosure may operate in a sleep mode. Messaging 508 may be used to store messages or commands coming to the gateway 500 for processing at the gateway level. A command may be received at the gateway 500 for changing a node feature of a connected node. The local gateway 500 may be operated as a node receiving messaging from a central gateway such as central gateway 300 described above and shown in FIG. 3 or the local gateway may operate a messaging queue 508 similar to the messaging 308 described above and shown in FIG. 3 or both.

When operating as a queue, the gateway messaging 508 may be used for relaying messages to other connected nodes. When the local gateway is connected to a main gateway 300, the local gateway may also receive messages from a central gateway queue 308. Commands such as reconfiguration commands may be received and or relayed as discussed above with respect to the example of FIG. 3. The gateway 500 may be used to deposit a received command as a message in a mailbox/message queue in messaging 508 for immediate or later relaying to a connected node.

The gateway 500 may be reconfigured or sensors 514 may be reconfigured when such commands are addressed to the gateway 500 or to sensors 514.

An optional modular input/output interface 518 is provided for allowing a local node output signal based on incoming information from the wireless sensors. In several non-limiting examples, the local signal output may be a conditional signal such as an alarm-based signal or the local output signal may be a continuous signal used for any desired local purpose. For example, a visual output on a monitor may be desired at a particular node location.

In another example, the modular interface may accept an external input for triggering a mode operation. Each node may be configured to operate in the network is several operational modes. As will be described in more detail later, each node may operate in a stand-alone mode, a continuous mode and in a sleep or low power mode.

Referring now to the several examples described above and shown in FIGS. 1 through 5, exemplary well site monitoring operations may now be described.

A well site 100 may be provided several monitoring devices for monitoring operations at the site. The monitoring devices are placed in communication with a local gateway such as the gateway 500 previously described. Multiple well sites may be monitored using more local gateways and/or multiple local gateways may be used at a single well site. The local gateways 500 are in communication with a main gateway, which may be similar to the main gateway 300 described earlier.

Remote users may communicate with the well site using a network topology. In one example a network topology may be similar to the network 200 described above. A user may communicate with any node level using only a single communication connection to the network. For example, user Modbus connection 210 communication with the network 200 over communication path 236. The user may address information to and receive information from any addressable node level or even sensor level if desired. Communication may be accomplished using any commercial radio at each node level where radio functions are selected to be imbedded in the node and implemented using the UCMP protocol and an embedded software agent radio controller to implement network functions.

In one example a user may communicate with a wireless sensor cluster 514 by addressing information to the sensor cluster 514 and sending the information via the central gateway 300. The central gateway 300 receives the information and polls the connected nodes for a matching ID. When a matching ID is determined, the central gateway controller may translate from a protocol in which it was received the information to use a protocol recognized by the addressed node. The information is then relayed by the main gateway to the addressed node and a response is received from the addressed node by the main gateway. The main gateway then may translate the response to use a user-recognized protocol and relay the information to the user.

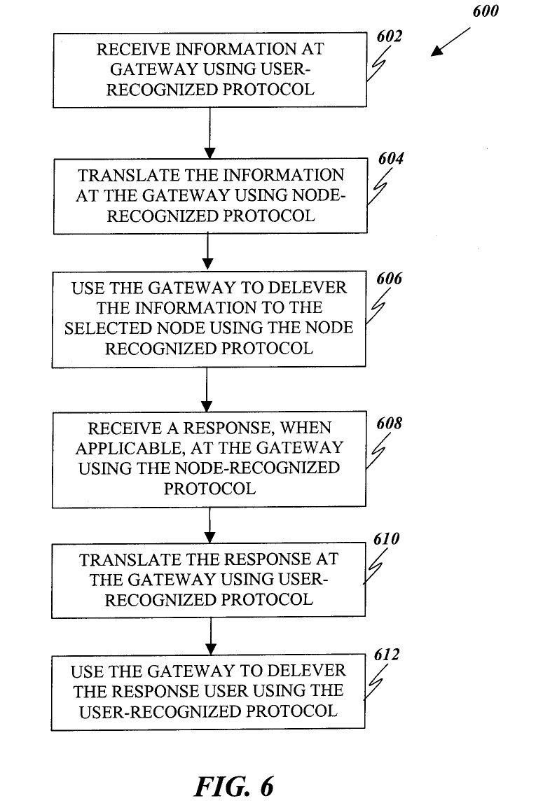

FIG. 6 illustrates a general method 600 used as a non-limiting example to illustrate a well monitoring operation according to the disclosure. The method 600 includes receiving information at a gateway using a user-recognized protocol 602 (for example Modbus RTU), and translating the information at the gateway for using a node-recognized protocol 604 (for example UCMP). The method 600 may also include using the gateway to deliver the information to a selected node using the node-recognized protocol 606 (UCMP). A response may then be received at the central gateway when applicable and the response may use the node-recognized protocol (Modbus RTU). The gateway may then translate the response at the gateway to use a user-recognized protocol 610 and the gateway may then deliver the translated response to the user using the user-recognized protocol.

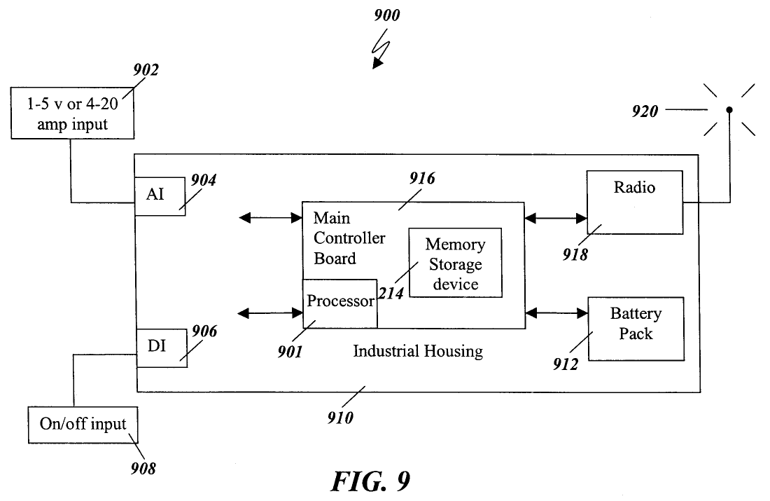

Turning now to FIG. 9, an illustrative embodiment of a transmission system is depicted. As shown in FIG. 9, transmission system 900 receives input from an analog device 902 in the form of 1 to 5 Volts or 4-20 milliamps. The analog input is provided by analog input device 904. The system 900 also receives digital input from a digital device 908 at digital input device 906. The system also includes a main controller board 916 which includes a processor and a computer readable medium 914 in which a set of computer readable instructions are stored in the computer readable medium for execution by the processor. The main controller board and processor are in data communication with transmitter radio 918 which transmits signals via transmitter antenna 920. A power supply or battery pack 912 is also incorporated into the system 900. An industrial housing 910 is provided for housing and detecting the transmitter system in a particular embodiment the housing 910 is a gas tight box or operating in an explosive environment.

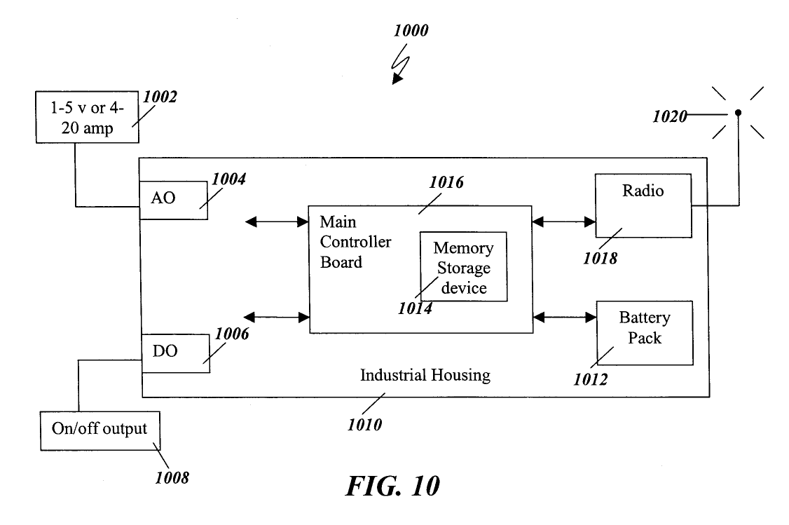

Turning now to FIG. 10, a receiver system 1000 is illustrated as provided in another illustrative embodiment. The receiver system receives signals from the transmitter system 100 via antenna 1020. The antenna 1020 is connected to a receiver radio 1018 which is in data communication with a main controller board on the receiver system 1000. The main controller board 316 includes a processor and a computer readable medium or memory storage device 114. The main controller board is in data communication with an analog output tool which outputs a configurable signal to analog output device 1002. Analog output device outputs an analog signal consisting of a1-5 volts or 4-20 milliamps output signal. Additional ranges of voltages and currents can also be used. The main controller board is also in data communication with a digital output device 1006 which outputs a digital data stream via a digital output device 1008.

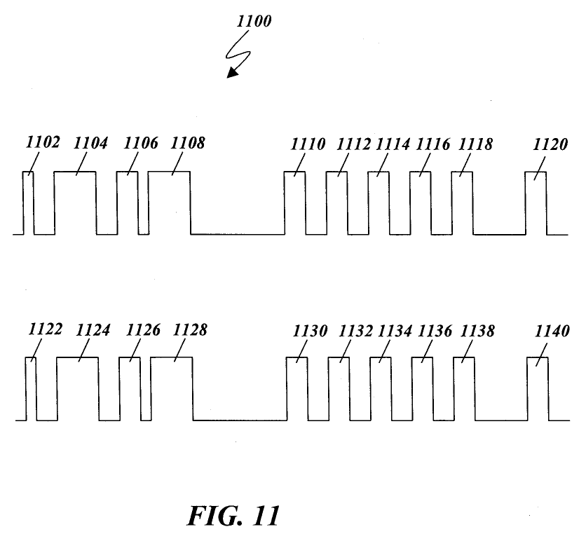

Turning now to FIG. 11, as shown in FIG. 11, a digital input data stream or analog signal is illustrated by the series of pulses 1102, 1104, 1106, 1108, 1110, 1112, 1114, 1116, 1118 and 1120. The analog or digital signals are received at the transmitter system 100 and transmitted by the transmitter system 100 to receiver system 200. The receiver system outputs the service of pulses is replicated by the receiver which substantially matches the input data stream. The output data stream is shown as a series of pulses 1122, 1124, 1126, 1128, 1130, 1132, 1134, 1136, 1138 and 1140.

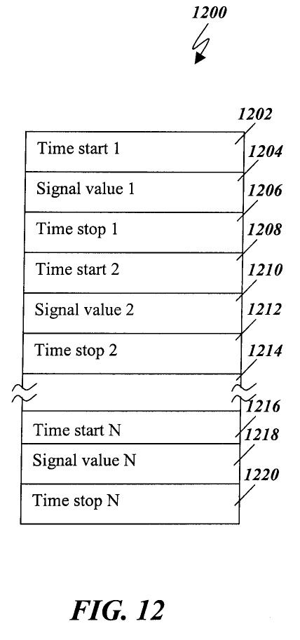

Turning now to FIG. 12, in an alternative embodiment a data structure is provided comprising data structure fields that retain data that represent data stored in a data buffer. The data structure represents a data buffer that comprises a data value for each signal change detected at the input to the transmitter. It another embodiment changed data values are stored in a data buffer and transmitted from the transmission buffer by the transmitter system to the receiver system. In a real-time transmission mode a signal value start and stop time value and data value are transmitted each time input signal change detection occurs. In a buffered transmission mode, a signal start and stop time is transmitted periodically.

As shown in FIG. 12, a data structure 1200 represents the data buffer. At 1202 the data structure embedded in a computer readable media, the data structure further includes a field for storing data indicative of a time start for data value for signal value 1 1204. At 1206 the data structure further includes field for storing data indicative of a stop time value for signal value 1. Another illustrative embodiment provides a data structure field for storing data representing the data buffer containing a signal value for each of a plurality of signal change values. In another particular embodiment, each of the signal values 1-N are presented by data values stored in the data structure. In another particular embodiment, each of the signal values 1-N are represented by data values stored in the fields in the data structure. In another particular embodiment, each of the signal change values 1-N is represented by data values stored in the data structure.

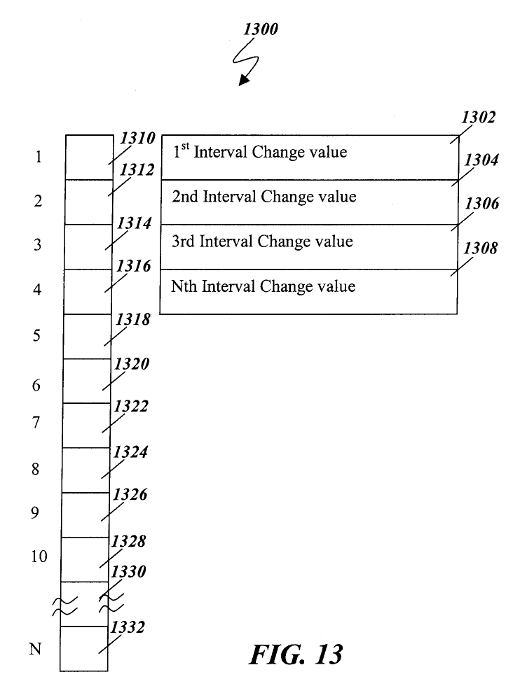

Turning now to FIG. 13 in another particular embodiment a data structure is provided comprising a bit array representing bits 1 through N and a set of interval change values for intervals 1-N. As shown in FIG. 13 a data structure 1300 comprises a set of bits 1310, 1312, 1314, 1316, 1318, 1320, 1322, 1324, 1326, 1328, 1330 and 1332 representing and on off state for bits 1 through N. In another particular embodiment the bit stream 1-N is presented in a bit array that represents changed data values for intervals 1 through N. The interval change data values corresponding to an interval indicated with a bit set to 1, are stored in a bit position in the bit array.

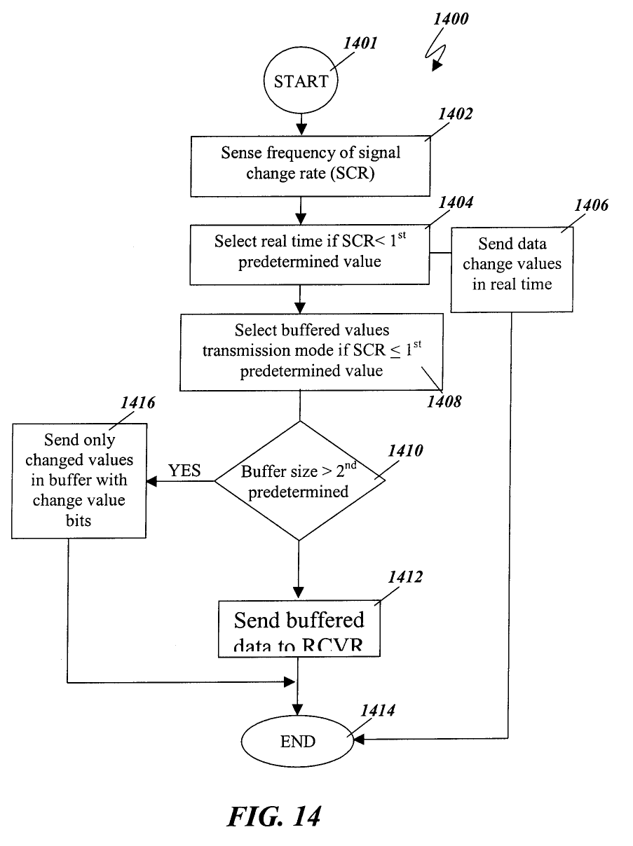

Turning now to FIG. 14, as shown in FIG. 14, a flowchart 1400 a series of functions performed in an illustrated embodiment are depicted. At block 1402 a frequency of signal change rate is detected. If the signal change rate is less than a first predetermined value, a real time transmission mode is selected at block 1404. In this case the illustrative embodiment proceeds to block 1406 and sends a data value in real time from the transmitter system to the receiver system. And the process ends at terminal 1414. If the signal change rate is less than the first predetermined value and any buffered transmission mode is selected at block 1408. If they available transmission buffer size is greater than a second predetermined value at block 1410 then the illustrative embodiment proceeds to block 1416 and sends only changed data values in a buffer along with a bit array indicating which intervals correspond to the changed data value. If the available transmission buffer size is less than or equal to the second predetermined value the embodiment proceeds to block 1412 and sends the buffered data to the receiver system. The illustrative embodiment then proceeds to terminal 1414 and ends.

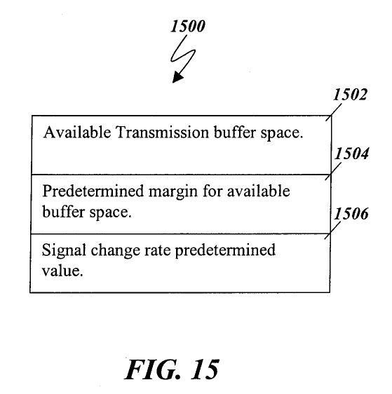

Turning now to FIG. 15, a data structure 1500 embedded in a computer readable medium is disclosed. A first field 1502 is disclosed for containing data indicative of available transmission buffer space. A second field 1504 is disclosed for containing data indicative of a predetermined margin by which the available buffer space must exceed a data buffer size to meet a condition. A third field 1506 is disclosed for containing data indicative of a signal change rate below which a real time transmission mode is, selected an above which a buffered transmission mode is selected.

The discussion above provides several illustrative embodiments of a well site monitoring apparatus and methods of monitoring a well site. In one particular embodiment, a well site monitoring apparatus comprises a first communication terminal and a receiver coupled to the first communication terminal that receives information using a first communication protocol. A transmitter coupled to the first communication terminal may be used to send information from the first communication terminal to a second communication terminal located at a well site using a second communication protocol. A controller is coupled to the first communication terminal operating a protocol translator to change the received information from the first communication protocol to the second protocol.

In another particular embodiment, a well site monitoring apparatus includes a radio operating as a receiver and transmitter. In another particular embodiment, a communication terminal includes an embedded radio controller to that controls any one of a plurality of radio types used as the receiver and the transmitter.

In another particular embodiment, a well site monitoring apparatus includes an embedded radio controller that comprises firmware instructions.

In another particular embodiment, a well site monitoring apparatus includes a first communication terminal that includes a messaging device that stores information prior to transmitting the information to the second communication terminal.

In another particular embodiment, a well site monitoring apparatus includes a communication interface that communicates using a wired connection for transmitting the information.

In another particular embodiment, a well site monitoring apparatus includes a communication interface that communicates using wireless short range UCMP.

In another particular embodiment, a well site monitoring apparatus includes a communication interface that communicates using wireless long range UCMP.

In another particular embodiment, a well site monitoring apparatus includes a communication interface that communicates using wireless long range Modbus.

A particular method embodiment for well site monitoring comprises receiving information using a first communication protocol at a first communication terminal using a receiver coupled to the first communication terminal, translating the received information from the first communication protocol to a second communication protocol using a controller coupled to the first communication terminal operating a protocol translator, and sending the information using a second communication protocol from the first communication terminal to a second communication terminal located at a well site using a transmitter coupled to the first communication terminal.

In another particular embodiment, a well site monitoring method includes using a radio as a receiver and a transmitter for wireless radio communication to send and receive information.

In another particular embodiment, a well site monitoring method includes controlling a radio by using a radio controller embedded in a communication terminal, the radio controller allowing the use of any one of a plurality of radio types as a receiver and a transmitter.

In another particular embodiment, a well site monitoring method includes controlling a radio using firmware instructions.

In another particular embodiment, a well site monitoring method includes storing received information in a messaging device in a first communication terminal prior to transmitting the information to a second communication terminal.

In another particular embodiment, a well site monitoring method includes using a wired connection for communication.

In another particular embodiment, a well site monitoring method includes using wireless short range UCMP.

In another particular embodiment, a well site monitoring method includes using wireless long range UCMP for communication.

In another particular embodiment, a well site monitoring method includes using wireless long range Modbus for communication.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Such insubstantial variations are to be considered within the scope of the claims below.

Given the above disclosure of general concepts and specific embodiments, the scope of protection is defined by the claims appended hereto. The issued claims are not to be taken as limiting Applicant's right to claim disclosed, but not yet literally claimed subject matter by way of one or more further applications including those filed pursuant to the laws of the United States and/or international treaty.

What is claimed is:

1. A well site data communication system comprising:
a receiver coupled to a first network node that receives information using a first communication protocol;
a transmitter coupled to the first network that sends information from the first communication terminal to a second network node located in a network at a well site using a second communication protocol; and
a processor coupled to the first communication terminal configured as a protocol translator to change the received information from the first communication protocol to the second communication protocol for communicating with a network node

2. A well site data communication apparatus according to claim 1, wherein the first communication protocol is a serial communication protocol and the second communication protocol is a parallel communication protocol.

3. A well site data communication apparatus according to claim 1, further comprising a mailbox flag indicating that a mailbox data is ready to be read by the first network node.

4. A well site data communication apparatus according to claim 1, wherein the communication terminal includes an embedded radio controller that controls any one of a plurality of radio types used as the receiver and the transmitter.

5. A well site data communication apparatus according to claim 4, wherein the embedded radio controller comprises firmware instructions in a computer readable medium wherein the instructions further comprise instructions to determine a radio type and instructions to translate a command to a protocol for the radio type.

6. A well site data communication system according to claim 1, wherein the first communication terminal includes a message storage mailbox that stores data prior to transmitting the information to the second network node.

7. A well site data communication system according to claim 1 further comprising a communication interface that communicates using an interface selected from the group consisting of a wired connection for transmitting the information, a communication interface that communicates using wireless short range unsolicited custom messaging protocol (UCMP), a communication interface that communicates using wireless long range UCMP and a communication interface that communicates using wireless long range MODBUS.

8. A well site data communication system according to claim 1 further comprising sensors in data communication with the first network node wherein the sensors are read and reported based on a command code received at the first communication terminal.

9. A well site data communication system according to claim 1, wherein the first network node and a second network are each in a mode selected from the group consisting of sleep, partial power, full power and continuous wherein the first network node and the second network node are in different modes.

10. A well site data communication system according to claim 9, wherein the first network node receives a command code to execute a command selected from the group consisting of change modes, read sensor, report, and reconfigure.

11. A well site data communication system according to claim 1, further comprising a plurality of nodes in a mesh network topology, wherein each one of the plurality of nodes are in direct communication with a third party device and with every other one of the plurality of nodes in the mesh network.

12. A method for well site data communication, the method comprising:
receiving data at a receiver coupled to a first network node using a first communication protocol;
translating the received data from the first communication protocol to a second network node; and
sending data from a transmitter coupled to the first network node to a second network node located at a well site using the second communication protocol.

13. The method of claim 12 wherein the first communication protocol is a serial communication protocol and the second communication protocol is a parallel communication protocol.

14. A well site data communication method according to claim 12, further comprising:
reading a mailbox flag indicating that a mailbox data is ready to be read by the first network node.

15. The well site data communication method according to claim 12, wherein the communication terminal includes an embedded radio controller that controls any one of a plurality of radio types used as the receiver and the transmitter.

16. The well site data communication method according to claim 15, wherein the embedded radio controller comprises firmware instructions in a computer readable medium wherein the instructions further comprise instructions to determine a radio type and instructions to translate command data to a protocol for the radio type.

17. The well site data communication method according to claim 12, wherein the first network node includes a message storage that stores data prior to transmitting the information to the second network node.

18. The well site data communication method according to claim 12, further comprising communicating data over a communication interface that communicates using an interface selected from the group consisting of a wired connection for transmitting the information, a wireless short range UCMP, a wireless long range UCMP and a wireless long range Modbus.

19. The well site data communication method according to claim 12, further comprising sensors in data communication with the first network node wherein the sensors are read and reported based on a command code received at the first network node.

20. The well site data communication method according to claim 12, wherein the first network node is in a mode selected from the group consisting of sleep, partial power, full power and continuous.

21. The well site data communication method according to claim 20, wherein the first network node receives a command code to execute a command selected from the group consisting of change modes, read sensor, report, and reconfigure.

22. The well site data communication method according to claim 12, further comprising a plurality of nodes in a mesh network topology, wherein each one of the plurality of nodes are in direct communication with a third party device and every other one of the plurality of nodes in the mesh network.
